(19) United States
(12) Patent Application Publication
(10) Pub. No.: US 2007/0274832 A1
(43) Pub. Date: Nov. 29, 2007

(54) Rotor For A Turbo Machine And Method For The Manufacture Of Such A Rotor

(75) Inventors: Gerhard Andrees, Muenchen (DE); Manfred Berthan, Olching (DE); Bertram Kopperger, Dachau (DE); Josef Kranzeder, Erding (DE); Raimund Lackermeier, Hallbergmoos (DE); Axel Rossmann, Karlsfeld (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 10/585,437

(22) PCT Filed: Dec. 22, 2004
(86) PCT No.: PCT/DE04/02798

§ 371 Date: Jul. 6, 2007

(30) Foreign Application Priority Data
Jan. 8, 2004 (DE) 10 2004 001 260.1

(51) Int. Cl. F01D 5/02; B23P 15/02

(52) U.S. Cl. 416/185; 29/889.23

(57) ABSTRACT

A rotor for a turbo machine, in particular for a gas turbine, is disclosed. The rotor includes a rotor base body and several rotor blades arranged over the circumference of the rotor base body, in which case the rotor base body is manufactured of an MMC composite material, and in which case the rotor blades are an integral part of the rotor. The rotor base body is configured in the shape of a ring, in which case the ring-shaped rotor base body includes, in a radially internal section, at least one groove-like recess which is filled radially on the inside with fibers exhibiting tensile strength.

This application claims the priority of International Application No. PCT/DE2004/002798, filed Dec. 22, 2004, and German Patent Document No. 10 2004 001 260.1, filed Jan. 8, 2004, the disclosures of which are expressly incorporated by reference herein.

### BACKGROUND AND SUMMARY OF THE INVENTION

The invention relates to a rotor for turbo machines, in particular, to a gas turbine. Further, the invention relates to a method for the manufacture of such a rotor.

Basically, referring to prior art, a distinction is made between two types of rotors for a turbo machine, namely so-called integrally bladed rotors of such rotors, in which the rotor blades are set by blade footings in the rotor. The present invention relates to integrally bladed rotors. Independent of whether a disk-shaped or ring-shaped rotor base body is present, these are referred to either as a Blisk (Bladed Disk) or as a Bling (Bladed Ring). In the case of such integrally bladed rotors, the rotor blades are rigidly connected to the ring-shaped or disk-shaped rotor base body and thus are an integral part of the rotor base body.

Modern turbo machines, in particular gas turbines such as aircraft engines, must satisfy the highest demands in view of reliability, weight, performance, economy and useful life. In order to achieve the above requirements that must be satisfied by a gas turbine, in particular its optimized weight, specifically the rotor must also be optimized in view of the above requirements. In so doing, the selection of material, as well as the search for new and suitable materials, play a decisive part. Prior art has already disclosed the use of fiber-reinforced composite materials as a weight-optimizing material. Such composite materials comprise a substrate material which is configured as a metal matrix, as well as fibers embedded in the substrate material. Such composite materials are also briefly referred to as metal matrix composites (MMC).

Referring to super-strong MMC materials which use titanium as substrate, the weight of components can be reduced by up to 50% compared with conventional titanium alloys. Reinforcements used are fibers displaying great strength and a high modulus of elasticity, for example SIC fibers.

Prior art has disclosed integrally bladed rotors using MMC construction with fiber reinforcements in the form of one or more relatively thin-walled cylindrical rings incorporated in a component having rotor blades. In accordance with prior art, this is achieved in that first the rings are wound separately and are compressed and welded together by means of a joining process in order to form a fiber-reinforced MMC material. These rings are machined, fitted together and again joined to each other by means of a joining process, as well as connected with the component that has the rotor blades and is to be supported. Such a design of an integrally bladed rotor in MMC construction has the disadvantage that joining zones are created between the rotor blades and the MMC rings. These joining zones exhibit relatively low strength, which is why only limited centrifugal forces can be absorbed. Joining zones always represent potential defects which cannot always be adequately detected with available non-destructive testing methods. Another disadvantage is that the manufacturing process used for prior-art integrally bladed rotors in MMC construction is complex and expensive.

Considering this, the object of the present invention is to suggest a novel rotor for a turbo machine, in particular a gas turbine, as well as a method for the manufacture of such a rotor.

In accordance with the invention, the rotor base body is configured in the shape of a ring, in which case the ring-shaped rotor base body comprises, in a radially internal section, at least one groove-like recess which is radially filled on the inside with fibers exhibiting tensile strength. Referring to the present invention, it is the first time that an integrally bladed rotor in combined Bling design and MMC construction has been suggested, the rotor not having a joining zone between the rotor blades and the MMC rings and thus exhibiting improved strength characteristics.

### BRIEF DESCRIPTION OF THE DRAWINGS

Preferred developments of the invention result from the description hereinafter. Examples of the invention are explained with reference to the drawings without, however, being restricted thereto.

FIG. 1 is a highly schematic sectional view of an inventive rotor in accordance with a first example of the invention, in cross-section; and,

FIG. 2 is a highly schematic sectional view of an inventive rotor in accordance with a second example of the invention, in cross-section.

### DETAILED DESCRIPTION OF THE DRAWINGS

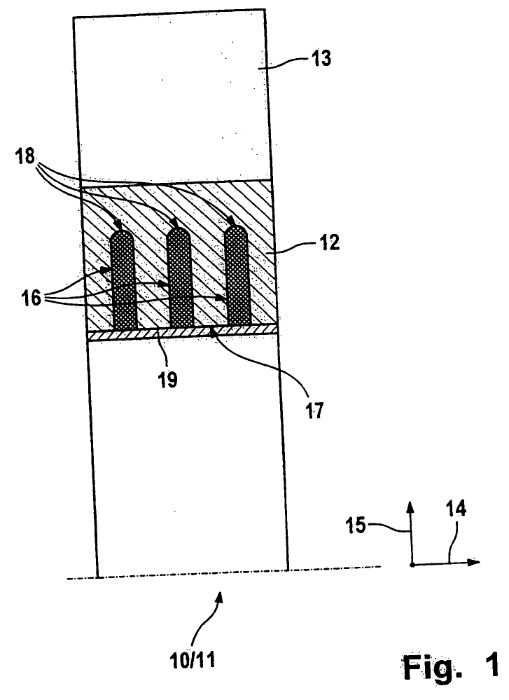

FIG. 1 shows a highly schematic cross-section of the inventive rotor 10, in which case the rotor 10 is an integrally bladed rotor. The rotor 10 consists of a ring-shaped rotor base body 11, in which case the rotor base body 11 comprises a radially internal section 12 and a radially external section 13. The radially external section 13 is used for the provision of several rotor blades. The radially internal section 12 is manufactured of an MMC composite material.

As already mentioned, FIG. 1 shows a cross-section of the rotor 10 or the rotor base body 11, in which case the axial direction of the rotor 10 in FIG. 1 is shown by an arrow 14. The radial direction of the rotor 10 is indicated by an arrow 15. The circumferential direction of the rotor 10 extends perpendicularly to the axial direction 14, as well as to the radial direction 15.

In accordance with FIG. 1, the rotor base body 11, i.e., the radially internal section 12 of the rotor base body, is provided with groove-like recesses 16. The groove-like recesses 16 extend starting from a radially internal generated surface 17 in a radial direction toward the outside. FIG. 1 shows that the dimensions of the recesses 16 are greater in radial direction (arrow 15) than in axial direction (arrow 14). Several recesses 16 are positioned successively in a row in the axial direction of the rotor 10 or of the rotor base body 11, extend exclusively in the radially internal section 12 of the rotor base body 11 and end at a distance from the radially external section 13 of the rotor base body. As is also illustrated in FIG. 1, the groove-like recesses 16 have, on a radially external boundary 18, a rounded or arcuate profile or a rounded or arcuate contour.

Within the meaning of the present invention, essentially groove-like recesses 16 extending in radial direction, as well as in circumferential direction, are filled radially internally with fibers exhibiting tensile strength. These fibers that exhibit tensile strength may be, for example, silicon carbide fibers. The rotor body 11 is made of a metal matrix material, in particular of titanium. By filling the recesses 16 with fibers, so-called MMC rings are produced.

As is illustrated in FIG. 1, the groove-like recesses 16 filled with fibers are limited on the radially internal generated surface 17, or on the radially internal end of the surface, by at least one cylindrical shell 19 of matrix material. The cylindrical shell 19 is required for manufacturing reasons; however, it does not absorb any forces and can thus be at least partially removed by machining during a subsequent machining step.

As a result of the above-described inventive design concept for an integrally bladed rotor 10, transversely extending—i.e., in axial direction as well as in circumferential direction-joining regions between the MMC rings, which are set in the radially internal section 12, and the rotor blades, which are provided by the radially external section 13, are avoided. As a result of this, the strength characteristics of the integrally bladed rotor 10 can be improved.

In order to manufacture the integrally bladed rotor 10 shown in FIG. 1, the procedure within the meaning of the present invention is such that, during a first step, a ring-shaped rotor base body 11 is provided, the rotor base body having a radially internal section 12 and a radially external section 13, and the radially external section 13 is used for the provision of rotor blades. Then the groove-like recesses 16 are provided in the radially internal section 12, namely in the radially internal generated surface 17 of the section. The groove-like recesses 16 thus are open on the radially internal end and extend in radial direction into the metal matrix material of the radially internal section 12 of the rotor base body 11. Furthermore, the recesses 16 are configured as closed ring-shaped grooves in circumferential direction. As already mentioned, the recesses 16 are provided in the radially internal section 12 of the rotor base body 11 in such a manner that the recesses 16 end radially outside at a distance from the radially external section 13 and have a rounded or arcuate contour on the corresponding boundary 18.

During a subsequent step of the inventive method, the groove-shaped recesses 16 that are open on the radially internal end, i.e., on the radially internal generated surface 17 of the rotor base body 11, are filled radially inside with fibers exhibiting tensile strength. These fibers exhibiting tensile strength are, in particular, silicon carbide fibers. However, it is also possible to use other fibers that exhibit tensile strength.

During a subsequent step of the inventive method, after the recesses 16 have been filled with fibers exhibiting tensile strength, the rotor base body 11 of the metal matrix material is compressed, together with the fibers exhibiting tensile strength located in the recesses 16 of the rotor base body 11, by applying pressure at high temperature. To achieve this, first the rotor base body filled with the fibers exhibiting tensile strength is positioned in a vacuum, whereby—in the vacuum—the recesses 16 that are filled with fibers and are still open on the radially internal end are closed in a gas-tight manner by at least one cylindrical shell 19 of metal matrix material. The thusly provided gas-tight capsule is then compressed by hot isostatic pressing. Consequently, only one joining zone is formed in this manner, i.e., in the region of the radially internal generated surface 17 of the rotor base body 11. Therefore, joining zones are placed in regions of the rotor 10 that are not critical from the viewpoint of strength.

Following compression, the rotor blades are formed by machining, in particular by milling, in the radially external fiber-free section 13. It is also possible to provide a rotor base body having a ring-shaped configuration already at the beginning of the inventive method, in which case the radially external section 13 of the rotor base body will already have the machined rotor blades. In this case, following compression of the rotor base body, the rotor blades would only be subject to a finishing process.

Therefore, within the meaning of the invention, an integrally bladed rotor manufactured of combined Bling construction and MMC construction is suggested, the rotor not having transversely extending joining zones between the rotor blades and the MMC reinforcement rings. This is particularly advantageous for reasons of strength.

Due to the arcuate contour of the recesses 16 on their radially external boundary 18, the transitions between the MMC rings and the metal matrix material can be optimized regarding strength. Thus cracks due to rigidity at the transition from the MMC rings to the matrix material are minimized.

Inasmuch as the dimensions of the recesses 16 are greater in radial direction than in their axial direction, the cross-sections of the MMC reinforcement rings are designed in such a manner that the reinforcement force is primarily transmitted by way of thrust forces.

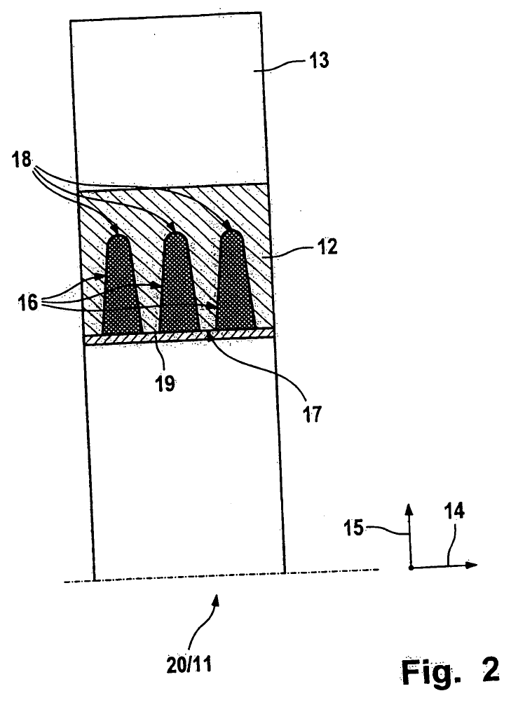

FIG. 2 shows a second embodiment of the invention, the embodiment essentially corresponding to the embodiment of FIG. 1. Therefore, in order to avoid unnecessary repetitions referring to the same assemblies, the same reference numbers are used. The embodiment of FIG. 2 differs from the embodiment of FIG. 1 only by the design of the cross-section of the recesses 16. In the embodiment of FIG. 1, the axially spaced apart boundary walls of the recesses 16 are essentially parallel to each other, while in the embodiment of FIG. 2 these walls include an angle in such a manner that the recesses 16 taper toward the outside in radial direction, i.e., exhibit a conical contour when viewed in cross-section. After the recess has been filled with the fiber exhibiting tensile strength, this results in MMC rings tapering in radial direction toward the outside, thus permitting further improvement of the strength characteristics of the rotor.

Finally, it should be pointed out again that, within the meaning of the present invention, an integrally bladed rotor in Bling construction is suggested, the rotor not exhibiting any strength-reducing joining zones extending in axial direction or circumferential direction between the rotor blades and the MMC reinforcement rings. The inventive integrally bladed rotor in Bling construction consists of a ring-shaped rotor base body which, in a radially external section, has rotor blades forming a blade ring or, in the radially external section, has a sufficiently large cross-section so that the rotor blades of the blade ring can be formed by machining. The MMC reinforcement rings are arranged in a radially internal section of the rotor base body, in which case the MMC reinforcement rings are manufactured in that groove-like recesses are filled on the inside with fibers exhibiting tensile strength. Thus, the recesses are open toward the inside in radial direction and, after having been filled, are closed by at least one cylindrical shell in a gas-tight manner in order to be subsequently compressed at high temperatures while pressure is applied. In this way, a particularly simple manufacture of an MMC Bling is achieved.

1-11. (canceled)

12. A rotor for a turbo machine, in particular for a gas turbine, comprising a rotor base body and several rotor blades arranged over a circumference of the rotor base body, wherein the rotor base body is manufactured of an MMC composite material, and wherein the rotor blades are an integral part of the rotor, and further wherein the rotor base body is configured in a shape of a ring and the ring-shaped rotor base body comprises, in a radially internal section, at least one groove-like recess which is filled radially on an inside with fibers exhibiting tensile strength.

13. The rotor according to claim 12, wherein, several recesses filled with fibers are arranged successively in a row in an axial direction of the rotor base body.

14. The rotor according to claim 12, wherein the recess, starting from a radially internal generated surface of the rotor base body, extends radially into the radially internal section of the rotor base body and ends at a distance from a radially external section of the rotor base body, wherein the external section forms the rotor blades.

15. The rotor according to claim 12, wherein the recess has a rounded or arcuate profile on a radially external boundary of the recess.

16. The rotor according to claim 12, wherein the recess has a greater dimension in a radial direction than in an axial direction.

17. The rotor according to claim 12, wherein the recess is limited on a radially internal end by at least one cylindrical shell of matrix material.

18. The rotor according to claim 12, wherein the recess has a conical cross-section in such a manner that the recess is tapered, starting from a radially internal end, in a radial direction.

19. A method for the manufacture of an integrally bladed rotor for a turbo machine, in particular for a gas turbine, comprising the steps of:
a) providing a ring-shaped rotor base body of metal matrix material with a radially internal section and with a radially external section, wherein the radially external section forms rotor blades;
b) applying at least one groove-like recess in the radially internal section of the rotor base body, in which case the recess is open on one radially internal end and ends at a distance from the radially external section;
c) filling the groove-like recess, from a radially internal direction, with fibers exhibiting tensile strength; and
d) compressing the rotor base body of metal matrix material and of the fibers exhibiting tensile strength by applying pressure at a high temperature.

20. The method according to claim 19, wherein, after filling the recess with fibers exhibiting tensile strength, the recess is closed in a gas-tight manner on the radially internal end by at least one cylindrical shell of matrix material by applying a vacuum.

21. The method according to claim 19, wherein the step of compressing is performed by hot isostatic pressing.

22. The method according to claim 19, wherein, following the compressing step, the rotor blades are machined, in particular by milling, in a region of a radially external fiber-free section.

23. A rotor for a turbo machine, comprising:
a rotor base body, wherein the rotor base body is formed of an MMC composite material and wherein the rotor base body defines, in a radial internal section of the rotor base body, a recess which is filled with reinforcing fibers; and
a rotor blade formed in a radial external section of the rotor base body.

24. The rotor according to claim 23, wherein the recess does not contact the rotor blade.

25. The rotor according to claim 23, wherein a radial external end of the recess is located at a distance from the radial external section of the rotor base body.

26. The rotor according to claim 23, wherein the filled recess forms an MMC ring.

27. The rotor according to claim 23, wherein the fibers are silicon carbide fibers.

28. A method for manufacturing an integrally bladed rotor for a turbo machine, comprising the steps of:
forming a groove in a radial internal section of a rotor base body formed of an MMC composite material;
filling the recess with reinforcing fibers;
compressing the rotor base body and the filled recess by applying pressure at a high temperature; and
forming a blade in a radial external section of the rotor base body.

29. The method according to claim 28, wherein the recess does not contact the rotor blade.

30. The method according to claim 28, wherein a radial external end of the recess is located at a distance from the radial external section of the rotor base body.

31. The method according to claim 28, wherein the fibers are silicon carbide fibers.
